(19) United States
(12) Patent Application Publication
(10) Pub. No.: US 2023/0374844 A1
(43) Pub. Date: Nov. 23, 2023

(54) Vehicle Having a Flap Unit for an Opening on the Vehicle

(71) Applicant: Witte Automotive GmbH, Velbert (DE)

(72) Inventors: Reinaldo Mensch, Wuppertal (DE); Ralf Höhn, Velbert (DE)

(73) Assignee: Witte Automotive GmbH, Velbert (DE)

(21) Appl. No.: 18/320,245

(22) Filed: May 19, 2023

(30) Foreign Application Priority Data
May 20, 2022 (DE) 10 2022 205 079.7

(51) Int. Cl. E05F 15/73; B60K 15/05

(52) U.S. Cl. CPC E05F 15/73; B60K 15/05; B60K 2015/0538; B60K 2015/053; E05Y 2400/44; E05Y 2900/53

(57) ABSTRACT

A vehicle having at least one vehicle exterior structure and a movable flap unit for covering an opening in the vehicle exterior structure, particularly a loading opening or tank opening of the vehicle. At least one gesture sensor module is provided and the flap unit has at least one screen which is mounted movably on the vehicle exterior structure. The screen covers the opening in the vehicle exterior structure in the closed position and releases access to the opening in the open position. The gesture sensor module is configured to detect a predetermined first actuation process and to trigger an opening process of the screen when the screen is closed, and to detect a predetermined second actuation process and to trigger a closing operation of the screen when the screen is open.

### BACKGROUND

The invention relates to a vehicle having a flap unit for covering an opening, in particular a loading opening or tank opening, on the vehicle.

In vehicles, openings in the vehicle body, such as a loading opening or tank opening, are closed by means of a screen or flap in order to prevent contamination and misuse.

### SUMMARY

The object of the present invention is to provide a vehicle having a flap unit for covering an opening on a vehicle, which flap unit is improved compared with the prior art, and is simple in design and easy to operate.

The vehicle according to the invention comprises at least one vehicle exterior structure and a flap unit (also referred to as a loading flap module) for covering an opening in the vehicle exterior structure, in particular a loading opening or tank opening, of the vehicle, at least one multi-sensor module, in particular a touch and/or gesture sensor module, being provided, and the flap unit comprising at least one screen which is mounted movably, in particular pivotably or displaceably, on the vehicle exterior structure, the screen covering the opening in the vehicle exterior structure in a closed position and releasing access to the opening in an open position.

A multi-sensor module is in particular a sensor module having detection of a plurality of different detection regions, for example a front (outer) detection region and a rear (inner) detection region, and/or a plurality of different detection functions, for example an opening function and a closing function, and/or a plurality of different detection types, for example a gesture detection and a touch detection.

The multi-sensor module is configured, for example, to detect a predetermined first actuation process, in particular a gesture and/or a touch, and to trigger an opening process of the screen and, in the case of an open screen, to detect a predetermined second actuation process, in particular a gesture and/or a touch, and to trigger a closing process of the screen.

In one possible embodiment, the multi-sensor module is designed as at least one touch sensor unit and/or gesture sensor unit. The multi-sensor module is preferably part of the flap unit, in particular of the screen. Alternatively or additionally, the multi-sensor module can be part of the vehicle exterior structure.

A development provides that the multi-sensor module is designed as an inner sensor module which is integrated in the flap unit, in particular in the screen. For example, the inner sensor module can be arranged on a rear side of the screen and/or in/on a carrier unit of the screen. For example, the multi-sensor module is arranged between the rear side of the screen and a surface side of the carrier unit which faces in the direction of the screen. The multi-sensor module can be formed in multiple parts, in particular from a plurality of sensor sub-modules, for example a stationary sensor sub-module and a flexible sensor sub-module.

Furthermore, the multi-sensor module can be designed in multiple parts and, for example, comprise an outer gesture sensor unit which is arranged externally in the region of the flap unit, and an inner gesture sensor unit which is arranged internally in the region of the flap unit. When a gesture movement is detected by means of the outer gesture sensor unit, the screen (also called loading flap) can be automatically moved out of the closed position, out of the region of the vehicle exterior structure, into an open position, in particular can be pivoted or displaced, in order to release the opening, or, when a gesture movement is detected by means of the inner gesture sensor unit, said screen can be automatically moved from the open position into the closed position.

The outer gesture sensor unit, in particular a detection region thereof, is accessible from the outside in particular when the flap unit is closed. The outer gesture sensor unit can be deactivated and/or not accessible from the outside when the flap unit is open. The inner gesture sensor unit, in particular a detection region thereof, is accessible from the outside in particular when the flap unit is open.

According to a development, the screen can be arranged flush with the vehicle exterior structure, in the closed position. The flap unit is in particular a loading flap module comprising an electrically driven loading flap (also referred to as loading screen or loading cover) or a tank flap module comprising an electrically driven tank flap (also called tank screen or tank cover) for a vehicle.

Preferably, the multi-sensor module, in particular the gesture sensor unit and/or the touch sensor unit, can be part of the vehicle exterior structure and/or of the flap unit.

For example, the multi-sensor module, optionally the gesture sensor unit, can be arranged above, below and/or to the side of the opening and/or on an outer side of the movable flap unit. In particular, the multi-sensor module, optionally the outer gesture sensor unit, can be integrated in an outer surface portion of the vehicle exterior structure and/or in an outer screen surface of the flap unit.

In addition, the inner gesture sensor unit can be arranged on an inside of the movable flap unit, in particular on an inside of the screen and/or on an inside of a screen carrier. For example, the inner gesture sensor unit may be integrated in an inner screen surface of the flap unit and/or in an inner carrier surface of the screen carrier.

In addition, the gesture sensor module can comprise a touch sensor unit (also called a touch sensor) which is integrated in an outer surface portion of the vehicle exterior structure and/or in an outer screen surface of the flap unit. In other words: Such a combination of a gesture sensor module (also referred to as a gesture sensor unit) and a touch sensor unit forms a multi-sensor module comprising at least two different detection types, detection functions and/or detection regions. For example, the gesture sensor module can be designed as a capacitive touch sensor or an inductive touch sensor.

For example, an opening function of the flap unit can take place by means of a hand movement on the outside of the gesture sensor module, optionally in the region of the outer gesture sensor unit, when the screen is closed. A closing function of the flap unit can take place by means of a hand movement inside the gesture sensor module, optionally in the region of the inner gesture sensor unit, when the screen is open, in particular in the region of the inside of the opened flap unit. For this purpose, the gesture sensor module, in particular the touch sensor unit and/or the gesture sensor unit, optionally the outer gesture sensor unit and/or the inner gesture sensor unit, is configured to detect an in particular predetermined gesture or gesture movement and/or a touch of a user, and to activate a function of the flap unit, in particular to activate an opening function or a closing function of the flap unit, on the basis of the detected, in particular predetermined, gesture or gesture movement and/or touch.

For example, the multi-sensor module, optionally the outer gesture sensor unit, can be configured to activate or trigger an opening function of the flap unit, in particular to open the screen, in the case of a first gesture movement, in particular a hand movement of a user, or a touch in the outer region of the closed screen. Alternatively or additionally, the multi-sensor module, optionally the inner gesture sensor unit, can be configured to activate or trigger a closing function of the flap unit, in particular to close the screen, by means of a second gesture movement, in particular a hand movement of the user, and/or a touch in the inner region of the open screen.

For adjusting the flap unit, in particular for adjusting the screen, the multi-sensor module, in particular the gesture sensor module (also gesture sensor unit) and/or the touch sensor unit, can be coupled to an adjusting mechanism, in particular a drive unit, by signal technology. The drive unit can, for example, be an electric motor.

### DESCRIPTION OF THE FIGURES

Embodiments of the invention are explained in greater detail below with reference to the accompanying drawings.

FIG. 1 shows schematically a vehicle exterior structure of a vehicle having a multi-sensor module and a flap unit in a closed position.

FIG. 2 shows schematically the vehicle exterior structure having the multi-sensor module and the flap unit in an open position.

FIG. 3 shows schematically the vehicle exterior structure having the multi-sensor module and the flap unit in the open position and before a closing movement.

FIG. 4 shows schematically an example of a multi-sensor module.

FIG. 5 shows schematically a vehicle exterior structure of a vehicle having an integrated multi-sensor module and a flap unit in a closed position.

FIG. 6 shows schematically the vehicle exterior structure having the integrated multi-sensor module and the flap unit in the open position and before a closing movement.

Parts corresponding to one another are provided with the same reference signs in all the drawings.

### DETAILED DESCRIPTION

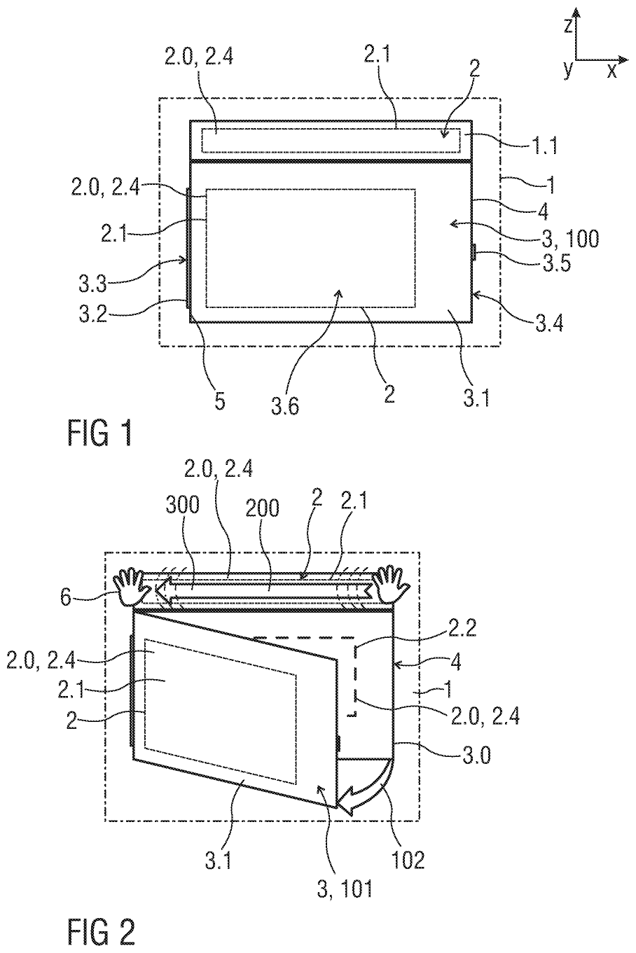

FIG. 1 schematically shows a vehicle exterior structure 1 of a vehicle (not shown in greater detail) having a multi-sensor module 2 and a flap unit 3 in a closed position 100.

The vehicle exterior structure 1 has an opening 4, in particular a hollow or through-opening, to a battery (not shown) or a tank (not shown).

The flap unit 3 is designed as a movable unit for covering the opening 4 in the vehicle exterior structure 1, in particular a loading opening or tank opening.

The flap unit 3 comprises at least one screen 3.1 which is mounted movably, in particular pivotably or displaceably, on the vehicle exterior structure 1. The screen 3.1 is designed for example as a closure lid or a closure flap for the loading or tank opening. The screen 3.1 can be discoid in design. Alternatively, the screen 3.1 can be designed in the form of a pot.

Facing away from the vehicle exterior structure 1, the screen 3.1 has a surface shape corresponding to the vehicle outer shell, in particular a largely planar or slightly curved shape. In the closed position 100, the screen 3.1 ends in particular flush with the vehicle exterior structure 1.

The screen 3.1 is configured such that it can be actuated and/or adjusted both electrically and manually.

The screen 3.1 can preferably be adjusted electrically. An electrical drive mechanism (not shown in greater detail) is coupled, for example, to an adjustment mechanism 3.2 for the screen 3.1 and can be formed, for example, as a motor drive, in particular a spindle drive or gear drive. The drive mechanism and the adjustment mechanism 3.2 are arranged at a drive end 3.3 of the screen 3.1 and are coupled thereto.

At a holding end 3.4 of the screen 3.1 opposite the drive end 3.3, said screen can be provided with a closure mechanism 3.5, for example a latching hook. The screen 3.1 can be detachably locked to the vehicle exterior structure 1 or a frame structure by means of the closure mechanism 3.5. For example, the closure mechanism 3.5 is formed as a latching mechanism, in particular an interlocking latching connection. In the closed position 100 of the screen 3.1, a counter-bearing for the drive end 3.3 of the screen 3.1 is thus formed on the holding end 3.4 of the screen 3.1 facing away from the drive.

In the direction of the vehicle exterior structure 1, the screen 3.1 can be provided, on the inside, with a seal (not shown), for example a sealing ring, sealing lips and/or a sealing strip. Additionally or alternatively, an edge of the opening 4 can be provided with a seal (not shown), in particular a sealing ring, sealing lips and/or a sealing strip, in the direction of the screen 3.1.

The adjustment mechanism 3.2 can alternatively be coupled to a manual actuating mechanism (not shown in greater detail) for the screen 3.1. Such a manual actuating mechanism is coupled in particular directly to the screen 3.1 and can be formed, for example, as a pressure actuator, in particular what is known as a push-push mechanism, on the screen 3.1.

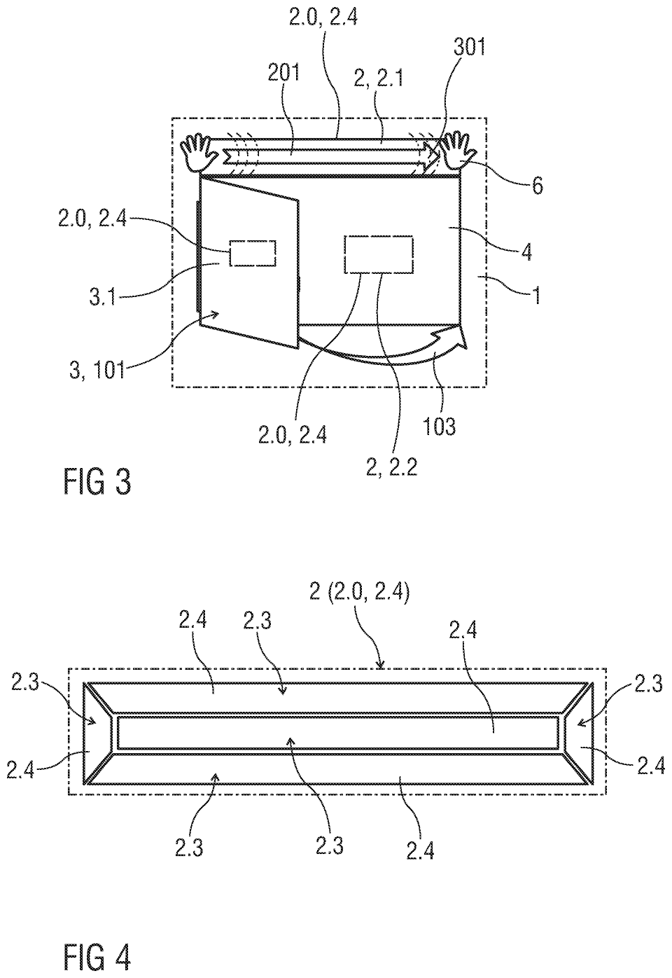

By means of the electrically driven adjustment mechanism 3.2, the screen 3.1 is movable, in particular pivotable about an axis of rotation 5, both in the case of an opening movement 102 (shown in FIG. 2) of the screen 3.1 from the closed position 100 into an open position 101 (shown in FIG. 2) and in the case of a closing movement 103 (shown in FIG. 3) of the screen 3.1 from the open position 101 into the closed position 100.

In order to move the screen 3.1 from the closed position 100, the electrically movable adjustment mechanism 3.2, in particular its drive mechanism, is coupled by signal technology to the multi-sensor module 2.

The multi-sensor module 2 is in particular a sensor module having detection of a plurality of different detection regions, for example a front (outer) detection region and a rear (inner) detection region, and/or a plurality of different detection functions, for example an opening function and a closing function, and/or a plurality of different detection types, for example gesture detection and touch detection.

The multi-sensor module 2 is configured, for example, to detect a predetermined first actuation process, in particular a gesture and/or a touch, and to trigger an opening process or an opening movement 102 of the screen 3.1 (shown in FIG. 2) when the screen 3.1 is closed, and to detect a predetermined second actuation process, in particular a gesture and/or a touch and to trigger a closing process or a closing movement 103 of the screen 3.1 when the screen 3.1 is open.

In one possible embodiment, the multi-sensor module 2 can comprise at least one integrated touch sensor unit 2.4 and/or an integrated gesture sensor unit 2.0. In this case, the multi-sensor module 2 can be designed as an integrated module and in particular can be part of the flap unit 3, for example part of the screen 3.1. Alternatively or additionally, the multi-sensor module 2 can be an integral part of the vehicle exterior structure 1 and can be arranged, for example, above the screen 3.1.

The multi-sensor module 2 can be formed in multiple parts. The multi-sensor module 2 can in particular be formed of a plurality of sensor sub-modules, for example a stationary sensor sub-module and a flexible sensor sub-module. The integrated touch sensor unit 2.4 can in particular be designed as a tactile sensor or pressure sensor. The integrated gesture sensor unit 2.0 can in particular be designed as a capacitive gesture sensor or an inductive gesture sensor.

For example, the integrated multi-sensor module 2 can be arranged on a rear side of the screen 3.1 and/or in/on a carrier unit of the screen 3.1. For example, the multi-sensor module 2 can be arranged between the rear side of the screen 3.1 and a surface side of the carrier unit facing in the direction of the screen 3.1.

The multi-sensor module 2 can additionally comprise an outer gesture sensor unit 2.1. The outer gesture sensor unit 2.1 is arranged externally in the region of the flap unit 3.

The outer gesture sensor unit 2.1 can for example be integrated above the opening 4 and/or above the flap unit 3, in an outer surface portion 1.1 of the vehicle exterior structure 1 and/or in an outer screen surface 3.6 of the movable screen 3.1.

For example, the outer gesture sensor unit 2.1 can be integrated, in particular overmolded, in an outer paintwork layer.

Alternatively or additionally, the multi-sensor module 2 can comprise further integrated gesture sensor units 2.0, optional outer gesture sensor units 2.1, and/or optional or integrated touch sensor units 2.4 which are integrated to the side of and/or below the opening 4 and/or to the side of and/or below the flap unit 3 and/or on an outer side of the flap unit 3, in particular the outer screen surface 3.6 of the movable screen 3.1.

The touch sensor unit 2.4 can, for example, be part of the outer gesture sensor unit 2.1 or the integrated gesture sensor unit 2.0, in particular form a portion thereof. Preferably, the entire outer gesture sensor unit 2.1 can additionally be designed as a touch sensor unit 2.4 and as a multi-sensor module 2. In other words: The multi-sensor module 2 can be designed as a combination of the integrated gesture sensor unit 2.0, the outer gesture sensor unit 2.1 and/or the integrated touch sensor unit 2.4. As a result, opening of the flap unit 3 can be activated or triggered both by gesture actuation by means of the gesture sensor unit 2.0 and/or 2.1, and by manual actuation by means of the integrated touch sensor unit 2.4 of the multi-sensor module 2.

FIG. 2 schematically shows the vehicle exterior structure 1 having the multi-sensor module 2 and the flap unit 3 in the open position 101.

The screen 3.1 is mounted movably on a screen carrier 3.0. In the example shown, the screen 3.1 is pivotably mounted on the screen carrier 3.0. Alternatively, the screen 3.1 can also be held extendably on the screen carrier 3.0 (not shown).

For opening the flap unit 3, the multi-sensor module 2 is provided, which module is configured to detect and identify a first gesture movement 200, in particular a predetermined movement of a hand 6 of a user according to arrow 300, in the region of the integrated gesture sensor unit 2.0 and/or the outer gesture sensor unit 2.1. When the first gesture movement 200 is identified, the screen 3.1 is automatically movable, in particular pivotable or displaceable, by means of a controller of the multi-sensor module 2, from the closed position 100 from the region of the vehicle exterior structure 1 into the open position 101, in order to release the opening 4.

Instead of the horizontal first gesture movement 200, another gesture representing the opening movement 102, for example a vertical gesture movement, can also be predetermined and stored for releasing the opening movement 102. Additionally or alternatively, when at least a part of the multi-sensor module 2 or the outer gesture sensor unit 2.1 is formed as a touch sensor unit 2.4, a touch detected by means of the touch sensor unit 2.4 for releasing the opening movement 102 can also be used.

In addition, an inner gesture sensor unit 2.2 can be integrated in the flap unit 3, in the open position 101 of the flap unit 3 a gesture representing a closing movement 103, for example a horizontal or vertical gesture movement, being detected by means of the inner gesture sensor unit 2.2 and a corresponding closing function being triggered. The inner gesture sensor unit 2.2 can be integrated, for example, in a screen carrier 3.0 or in the screen 3.1.

In other words, the multi-sensor module 2, in particular the integrated gesture sensor unit 2.0, the outer gesture sensor unit 2.1, optionally in combination with the touch sensor unit 4.4, is configured to detect the predetermined first gesture movement 200 and optionally the touch of a user, and to activate a function of the flap unit 3, in particular to activate the opening function, on the basis of the detected predetermined first gesture movement 200 or the touch.

FIG. 3 schematically shows the vehicle exterior structure 1 having the multi-sensor module 2 and the flap unit 3 in the open position 101 and before a closing movement 103.

For closing the flap unit 3, the multi-sensor module 2 is provided, which is configured to detect a second gesture movement 201, in particular a predetermined movement of the hand 6 of a user according to arrow 301 in the region of the outer gesture sensor unit 2.1. When a second gesture movement 201 is detected, the screen 3.1 is automatically movable, in particular pivotable or displaceable, by means of a controller of the gesture sensor module 2, from the open position 101 into the closed position 100, in order to close the opening 4 again.

In other words, the multi-sensor module 2, in particular the outer gesture sensor unit 2.1, is configured to detect the predetermined second gesture movement 201 of a user and to activate a function of the flap unit 3, in particular to activate the closing function, on the basis of the detected predetermined second gesture movement 201.

The multi-sensor module 2 for the flap unit 3 enables intuitive actuation of the flap unit 3.

FIG. 4 schematically shows an example of a multi-sensor module 2. The multi-sensor module 2, in particular the respective gesture sensor unit 2.0, 2.1, 2.2, can comprise a plurality of, for example five, sensor surfaces 2.3. The sensor surfaces 2.3 can be configured to detect the respective gesture movement 200, 201. Furthermore, the sensor surfaces 2.3 are configured in such a manner that they reliably detect incorrect triggering, for example by rain, snow, high-pressure cleaners, a car wash, etc., and suppress them by means of correspondingly integrated software filters.

In addition, the sensor surfaces 2.3 can be designed as a touch sensor unit 2.4. As a result, opening or closing of the flap unit 3 can be activated or triggered both by gesture actuation by means of the sensor surfaces 2.3 and by manual actuation by means of the touch sensor unit 2.4 of the multi-sensor module 2.

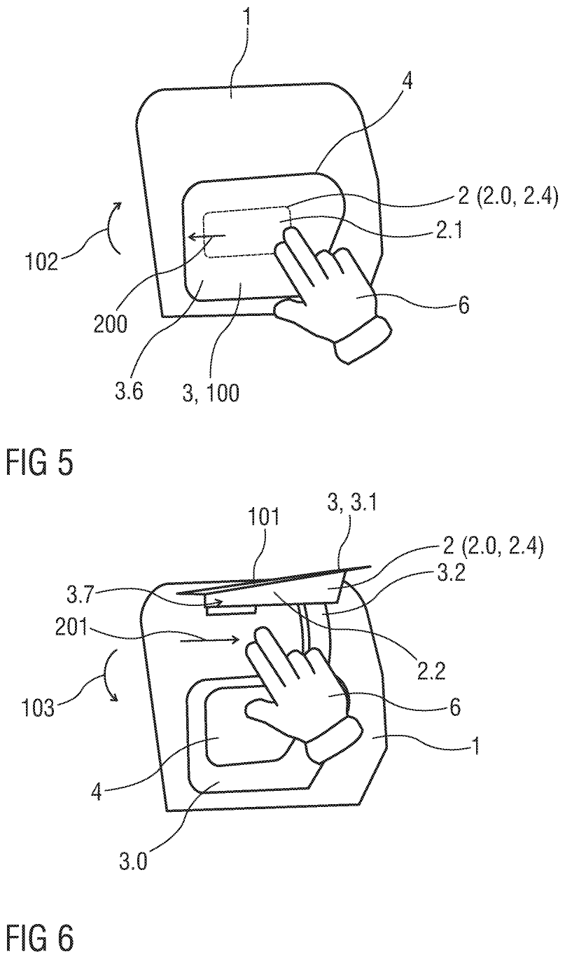

FIG. 5 schematically shows the vehicle exterior structure 1 having a multi-sensor module 2 integrated in the flap unit 3, in particular in the outer screen surface 3.6, and optionally an integrated outer gesture sensor unit 2.1 and the flap unit 3 in the closed position 100.

The function of this outer gesture sensor unit 2.1 integrated in the flap unit 3 corresponds to the respective function of the previously described multi-sensor module 2 integrated in the screen 3.1, the previously described outer gesture sensor unit 2.1 integrated in the screen 3.1, the previously described inner gesture sensor unit 2.2 integrated in the screen 3.1 and/or in the screen carrier 3.0, and/or the previously described outer gesture sensor unit 2.1 integrated in the vehicle exterior structure 1.

The outer gesture sensor unit 2.1 integrated into the outer screen surface 3.6 of the movable screen 3.1 of the flap unit 3 detects a first gesture movement 200 of the hand 6 of a user and activates a corresponding opening movement 102. The structure of the flap unit 3 according to FIGS. 5 and 6 differs from the structure of the flap unit 3 according to FIGS. 1 to 4 in that, instead of the axis of rotation 5, an adjustment mechanism 3.2 is provided, which brings about an arcuate deployment movement of the flap unit 3 upwards out of the opening 4, into an open position 101 above the opening 4, as shown in FIG. 6.

FIG. 6 schematically shows the vehicle exterior structure 1 having the multi-sensor module 2 integrated in the flap unit 3 and the inner gesture sensor unit 2.2, optionally integrated in the flap unit 3, and the flap unit 3 in the open position 101 and before a closing movement 103.

The inner gesture sensor unit 2.2 is arranged internally, in the region of the flap unit 3. The inner gesture sensor unit 2.2 can be arranged, in particular integrated, in the screen support 3.0, which is arranged and held in a form-fitting manner in the vehicle exterior structure 1, and/or on an inner screen surface 3.7 of the movable screen 3.1.

The inner gesture sensor unit 2.2 integrated in the flap unit 3 detects a second gesture movement 201 of the hand 6 of a user, and activates a corresponding closing movement 103.

It is also possible for just a single multi-sensor module 2 having an integrated gesture sensor unit 2.0 and/or integrated touch sensor unit 2.4 to be integrated or arranged in the flap unit 3, in particular in the screen 3.1, the multi-sensor module 2 being configured to detect the respective gesture movement 200, 201 outside or inside, and/or touch outside on an outer surface of the screen 3.1 or on inside on an inner surface on the screen 3.1, when the screen 3.1 is closed and when the screen 3.1 is open, respectively.

### LIST OF REFERENCE SIGNS

1 vehicle exterior structure
1.1 outer surface portion
2 multi-sensor module
2.0 integrated gesture sensor unit
2.1 outer gesture sensor unit
2.2 inner gesture sensor unit
2.3 sensor surface
2.4 integrated touch sensor unit
3 flap unit
3.0 screen carrier
3.1 screen
3.2 adjustment mechanism
3.3 drive end
3.4 holding end
3.5 closure mechanism
3.6 outer screen surface
3.7 inner screen surface
4 opening
5 axis of rotation
6 hand
100 closed position
101 open position
102 opening movement
103 closing movement
200 first gesture movement
201 second gesture movement
300, 301 arrow

1-10. (canceled)

11. A vehicle having at least one vehicle exterior structure and a movable flap unit for covering an opening in the vehicle exterior structure, in particular a loading opening or tank opening of the vehicle,
wherein at least one multi-sensor module is provided and the flap unit comprises at least one screen which is mounted movably, in particular pivotably, on the vehicle exterior structure,
wherein the screen covers the opening in the vehicle exterior structure in a closed position, and releases access to the opening in an open position,
wherein the multi-sensor module is configured to detect a predetermined first actuation process and to trigger an opening process of the screen when the screen is closed, and to detect a predetermined second actuation process and to trigger a closing operation of the screen when the screen is open.

12. The vehicle according to claim 11, wherein the multi-sensor module is designed as at least one touch sensor unit and/or a gesture sensor unit.

13. The vehicle according to any of claim 11, wherein the multi-sensor module is part of the vehicle exterior structure and/or part of the flap unit.

14. The vehicle according to any of claim 11, wherein the multi-sensor module is designed as an inner sensor module, which is integrated into the flap unit, in particular into the screen.

15. The vehicle according to claim 14, wherein the inner sensor module is arranged on a rear side of the screen and/or in a carrier unit of the screen.

16. The vehicle according to claim 11, wherein the multi-sensor module additionally comprises an outer gesture sensor unit, which is arranged externally in the region of the flap unit, and an inner gesture sensor unit, which is arranged internally in the region of the flap unit, and the screen either being movable automatically, when a first gesture movement is detected by means of the outer gesture sensor unit, from the closed position from the region of the vehicle exterior structure, into an open position, in order to release the opening, or being movable automatically, when a second gesture movement is detected by means of the inner gesture sensor unit and/or the outer gesture sensor unit, from the open position into the closed position.

17. The vehicle according to claim 16, wherein the multi-sensor module, optionally the outer gesture sensor unit and/or the inner gesture sensor unit, is/are configured to detect a gesture or a gesture movement and/or a touch of a user as one of the actuation processes, and to activate a function of the flap unit on the basis of the detected gesture or gesture movement and/or touch.

18. The vehicle according to claim 17, wherein the multi-sensor module, optionally the outer gesture sensor unit, is configured to activate an opening movement of the flap unit when a first gesture movement or touch in the outer region of the closed screen is detected, and to activate a closing movement of the flap unit when a second gesture movement is detected in the inner region of the opened screen.

19. The vehicle according to any of claim 17, wherein an integrated touch sensor unit is configured to activate an opening movement upon detection of a touch or actuation on an outer surface of the closed screen, and to activate a closing movement of the flap unit on an inner surface of the open screen.

20. The vehicle according to claim 11, wherein the multi-sensor module is coupled by signal technology to a drive mechanism for an adjustment mechanism for adjusting the flap unit.
